(19) United States
(12) Patent Application Publication
(10) Pub. No.: US 2005/0151436 A1
(43) Pub. Date: Jul. 14, 2005

(54) Gear motor assembly for floor care applications

(76) Inventors: Scott R. Lantzy, Berea, OH (US); Jeffrey N. New, Aurora, OH (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/757,169

(22) Filed: Jan. 14, 2004

(51) Int. Cl. H02K 7/10; H02K 7/06; H02P 15/00

(52) U.S. Cl. 310/99; 310/83; 310/75 R; 74/606 R

(57) ABSTRACT

A gear motor assembly comprises an electric motor, and one or more gear reducers comprising first and second spiral bevel gears. The gear motor assembly is configured to power one or more implements such as floor care brushes, burnish drives, polishers, rotary finishers, and the like.

### BACKGROUND OF THE INVENTION

1. Field of the Invention

The present invention relates generally to gear motors, and in particular, to gear motors for use with electromechanical devices such as floor care brushes, burnish drives, polishers, rotary finishers, and the like.

2. Discussion of the Related Art

Floor care applications such as cleaning, polishing, or finishing a floor's surface require mechanical power to rotate, at a controlled speed, a flat circular bristle brush and/or a flat circular burnishing pad to clean, shine or finish floors or surfaces made of various materials.

Prior floor care brush drives have included gear motors with helical, in-line type, planetary type, and right angle worm gear-type gear motors. Each type of gear motor consisted of either one or two-speed reducers mounted directly onto an electric AC or a DC motor. In the case of helical, in-line and planetary type brush drives the mounting position of the drive on the floor care machine is vertical (i.e., perpendicular to the floor). The mounting position of the brush drive for right angle worm gear types is horizontal (i.e., parallel to the floor).

Selection among the various gear motor types has depended upon the design constraints. The right angle, worm-gear type gear motor has a lower height or profile than the helical motors. Generally, helical, in-line, and planetary type reducers and/or brush drives rely on rolling action between their gear sets (teeth) and will have an efficiency advantage over right angle worm gear types that rely upon a sliding action between their gears. The worm-gear types have a corresponding increased friction and decreased efficiency and therefore require more power or energy to do an equal amount of work.

### SUMMARY OF THE INVENTION

Accordingly the present invention comprises a gear motor assembly having a low profile and increased efficiency. The gear motor assembly comprises an electric motor, and one or more spiral bevel gear reducers. The assembly is configured in a number of embodiments, including single shaft for powering one implement, and dual shaft for powering multiple implements.

These and other objects and advantages of the present invention will be classified in the following description of the preferred embodiment in connection with the drawings, the disclosure and the appended claims, wherein like reference numerals represent like elements throughout. The drawings constitute a part of this application and include exemplary embodiments of the present invention and illustrate various features thereof.

### BRIEF DESCRIPTION OF THE DRAWINGS

FIG. 1 is a side elevational view illustrating an exemplary single shaft embodiment of the gear motor assembly of the present invention.

FIG. 2 is a bottom view of the gear motor assembly of FIG. 1 the present invention.

FIG. 3 is a partial sectional view of the gear motor assembly of FIG. 2 showing a gear box or reducer thereof taken along line A-A of FIG. 2.

FIG. 4 is a side elevational view illustrating an exemplary second embodiment of the present invention comprising a dual shaft gear motor.

FIG. 5. is a bottom of the gear motor assembly of FIG. 4.

FIG. 6 is a partial sectional view of the gear motor assembly of FIG. 5 taken along line B-B thereof.

### DETAILED DESCRIPTION OF THE PREFERRED EMBODIMENTS

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated.

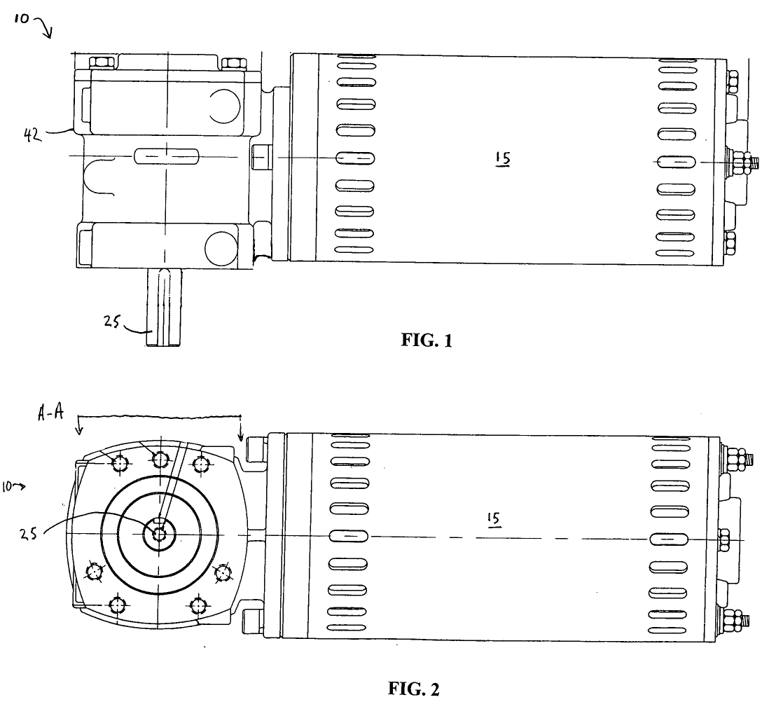

Referring to the drawings in greater detail, FIGS. 1-3 illustrate a first embodiment of the present invention comprising a single-shaft gear motor assembly 10. The gear motor assembly generally comprises an electric motor 15, a gear train or reducer 20 and an output shaft 25.

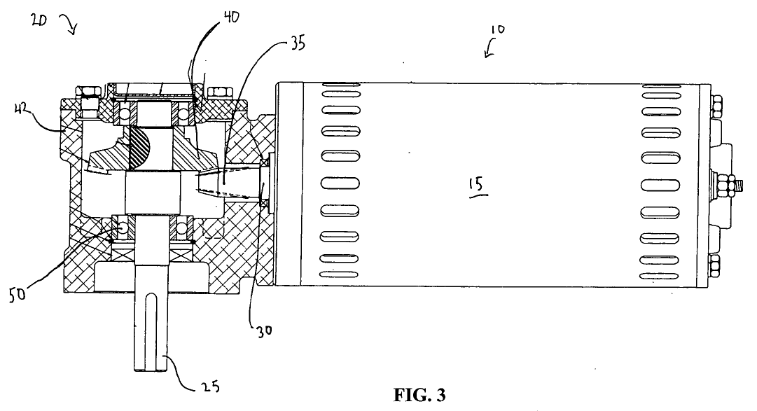

The electric motor 15 can be powered, for example, from direct current (DC) provided by a battery (not shown) or by alternating current (AC) powered through a cord from an electrical outlet (not shown). Referring to FIG. 3, the electric motor 15 powers a rotor or armature 30. The motor 15 may be constant speed or variable speed.

The reducer 20 comprises a first spiral bevel gear 35 (or input pinion gear) and a second spiral bevel gear 40 (or output gear) enclosed within housing 42. Spiral bevel gears 35, 40, which are well known in the art, are standard available gears employing tapered elements.

As illustrated in FIG. 3, first spiral bevel gear 35 may be manufactured integral to the armature 30. As is well known in the art, the gear 35 may also be provided independent from the armature 30, in which case bearings (not shown) and a coupling device (not shown) are provided such that armature 30 drives gear 35.

Gear 35 engages the second spiral bevel gear 40. As illustrated in FIG. 3, in a preferred embodiment the axis of rotation of the gears 35,40 form a 90 degree angle resulting in a right angle first stage gear engagement. Such an engagement provides maximum power delivery. The angle between gears 35, 40 need not be 90 degrees. For example, if a lower or higher profile is desired, the angle between gears 35, 40 can be increased to form a convex angle, or decreased to form a concave angle accordingly. Gear 40 powers rotation of output shaft 25. Output shaft 25 can be manufactured integral to gear 40, or manufactured independently and affixed to the gear 40, for example by keying. Output shaft 25 can be supported within the housing by fixed position bearings 50.

In operation, a bristle brush, burnishing pad, or other floor care implement (not shown) is removably affixed or attached to an end of the output shaft 45. The implements are interchangeable. During operation the motor via the reducer powers rotation of the implement.

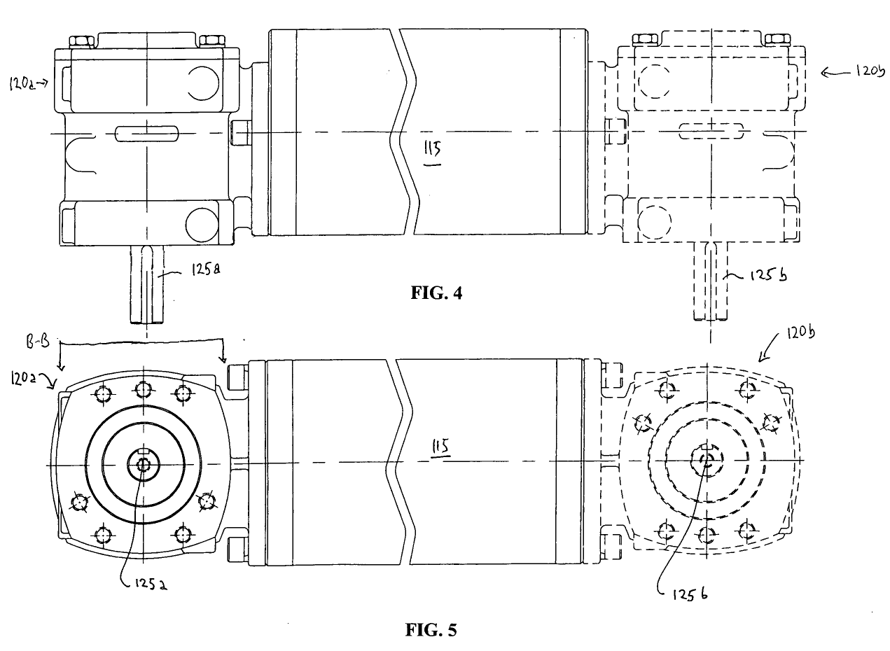

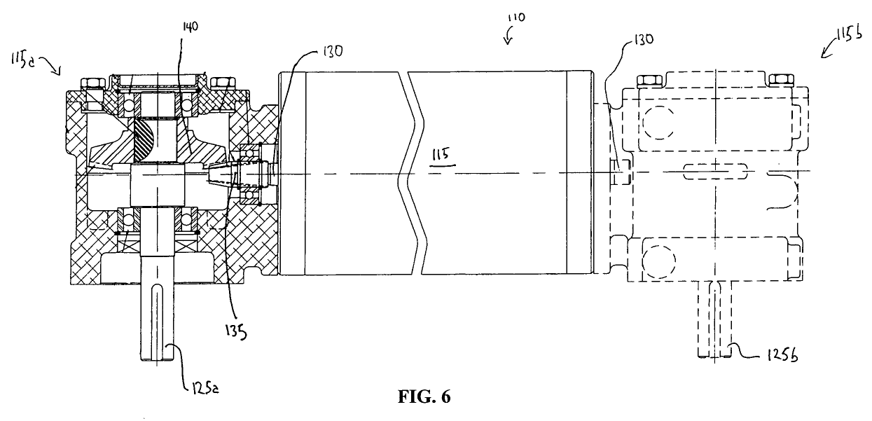

FIG. 4-6 illustrate a second embodiment of the present invention comprising a dual-shaft spiral bevel gear motor assembly 110. The gear motor assembly 110 differs from the previously described embodiment in that an armature at opposite ends opposite ends 130a, 130b of motor 115 power a plurality of implements (not shown) through first and second reducers 120a, 120b and first and second output shafts 125a, 125b. Referring to FIG. 6, the reducers 120a, 120b each comprise first and second spiral bevel gears 135, 140 as discussed in the previous embodiment. Operation of the gear motor assembly is as discussed in the previous embodiment, except that multiple implements may be attached via output shafts 125a, 125b.

Although the foregoing detailed description of the present invention has been described by reference to two exemplary embodiments, and the best mode contemplated for carrying out the present invention has been shown and described, it will be understood that modification or variations in the structure and arrangement of this embodiment other than those specifically set forth herein may be achieved by those skilled in the art and that such modifications are to be considered as being within the overall scope of the present invention. Therefore, it is contemplated to cover the present invention and any and all modifications, variations, equivalents that fall with in the true spirit and scope of the underlying principles disclosed and claimed herein. Consequently, the scope of the present invention is intended to be limited only by the attached claims.

1. A gear motor assembly for use in floor care applications, comprising:
(a) a motor having an armature;
(b) a first bevel gear integral to said armature;
(c) a second bevel gear operably associated with said first bevel gear; and
(d) an output shaft operably associated with said second bevel gear.

2. The gear motor assembly of claim 1, further comprising an implement operably associated with said output shaft.

3. The gear motor assembly of claim 1 wherein said first bevel gear and said second bevel gear engage at a ninety degree angle.

4. The gear motor assembly of claim 1 wherein said first bevel gear and said second bevel gear engage at a concave angle.

5. The gear motor assembly of claim 1 wherein said first bevel gear and said second bevel gear engage at a convex angle.

6. A floor care assembly, comprising:
(a) a motor having an armature;
(b) a reducer operably engaged with said armature, said reducer comprising first and second bevel gears, said first bevel gear integral to said armature;
(c) an output shaft in operable association with said reducer; and
(d) an implement in operable association with said reducer.

7. The gear motor assembly of claim 6 wherein said first bevel gear and said second bevel gear engage at a ninety degree angle.

8. The gear motor assembly of claim 6 wherein said first bevel gear and said second bevel gear engage at a concave angle.

9. The gear motor assembly of claim 6 wherein said first bevel gear and said second bevel gear engage at a convex angle.

10. A gear motor assembly for use in floor care applications, comprising:
(a) a motor with first and second ends;
(b) an armature in operable association with said motor;
(c) a first reducer adjacent said first end in operable association with said armature and a second reducer adjacent said second end in operable association with said armature;
(d) a first output shaft in operable association with said first reducer and a second output shafts in operable association with said second reducer; and
(e) wherein said first reducer and said second reducer each comprises first and second bevel gears.

11. The gear motor assembly of claim 10, further comprising a plurality of implements operably associated with said first and second output shafts.

12. The gear motor assembly of claim 10 wherein said first bevel gear and said second bevel gear engage at a ninety degree angle.

13. The gear motor assembly of claim 10 wherein said first bevel gear and said second bevel gear engage an at a concave angle.

14. The gear motor assembly of claim 10 wherein said first bevel gear and said second bevel gear engage at a convex angle.

15. A gear motor assembly for use in floor care applications comprising:
(a) a motor having an armature;
(b) a first bevel gear operably associated with said armature;
(c) a second bevel gear operable associated with said first bevel gear; and
(d) an output shaft operably associated with said second bevel gear,
wherein said first bevel gear and said second bevel gear engage at a concave angle.

16. A gear motor assembly for use in floor care applications comprising:
(a) a motor having an armature;
(b) a first bevel gear operably associated with said armature;
(c) a second bevel gear operably associated with said first bevel gear; and
(d) an output shaft operably associated with said second bevel gear,
wherein said first bevel gear and said second bevel gear engage at a convex angle.
